(19) United States
(12) Patent Application Publication
(10) Pub. No.: US 2025/0310730 A1
(43) Pub. Date: Oct. 2, 2025

(54) CELLULAR FEEDER CONTROLLER WITH INTEGRATED SECURITY, WATER QUALITY MONITORING, AND HARDWARE FAILURE DETECTION

(71) Applicant: WA Consulting LLC, Lincoln, NE (US)

(72) Inventor: WALKER ARCE, Lincoln, NE (US)

(21) Appl. No.: 19/093,816

(22) Filed: Mar. 28, 2025

Related U.S. Application Data
(60) Provisional application No. 63/571,278, filed on Mar. 28, 2024.

(51) Int. Cl. H04W 4/30; A01K 5/02; A01K 7/02

(52) U.S. Cl. CPC H04W 4/30; A01K 5/02; A01K 7/02

(57) ABSTRACT

A wildlife feeder timer and system is provided. More specifically, the present invention relates to a wildlife feeder device, its control systems, and methods for monitoring environmental conditions and dispensing wildlife feed. The wildlife feeder timer further comprises processors, circuitry, and is configured to interface with external devices such as sensors, motors, and actuators, cloud servers, one or more wildlife feeders, and to connect to one or more networks.

### CROSS-REFERENCE TO RELATED APPLICATIONS

This application claims priority pursuant to 35 U.S.C. 119(e) to co-pending U.S. Provisional Patent Application Ser. No. 63/571,278, filed Mar. 28, 2024, the entire disclosure of which is incorporated herein by reference.

### FIELD OF THE INVENTION

The present invention relates generally to wildlife feeders. More specifically, the present invention is concerned with automated fish and game feed dispensing systems and methods that further includes environmental monitoring.

### BACKGROUND

Wildlife feeders are essential tools for providing sustenance to various species in their natural habitats. However, current designs of wildlife feeders present several challenges that limit their effectiveness and efficiency.

One significant problem with existing wildlife feeder control electronics, hereafter referred to as a “feeder timer or feeder timers”, is their incompatibility with multi-motor devices. Many feeder timers are designed to operate with a single motor, which restricts their functionality and adaptability. This limitation prevents the integration of advanced mechanisms that could enhance the feeding process. Additionally, existing wildlife feeder timers are not adaptable for multi feeder systems. In environments where multiple feeders are necessary to cater to different species or large populations, current designs fail to offer a cohesive system that can operate efficiently. This lack of adaptability results in increased complexity and maintenance requirements.

Efficiency in food disbursement is another critical issue with existing wildlife feeders. Many feeders do not distribute food evenly or effectively, leading to uneven feeding opportunities for wildlife. This inefficiency can result in some animals receiving more food than necessary while others receive insufficient amounts. Moreover, existing wildlife feeders fail to comprehensively utilize environmental information in connection with food disbursement. Many factors such as weather conditions, time of day, and animal activity levels are not considered in totality regarding in the feeding process, which contribute to reduced food distribution optimization and minimizing waste. The issue of food wastage is prevalent in current wildlife feeder designs. Inefficient disbursement mechanisms and lack of adaptability contribute to significant amounts of food being wasted, which not only increases costs but also impacts the sustainability of feeding programs.

Existing wildlife feeders encounter significant challenges in effectively distributing food based on environmental conditions. One primary issue is the inability to adjust the amount of food dispensed according to varying environmental information. This inadequacy frequently results in overfeeding, where excess food is left uneaten and subsequently decomposes. The decomposition of uneaten wildlife feed can release toxic chemicals, posing a risk to wildlife. For instance, decomposing feed can emit harmful compounds such as ammonia and nitrate, which can adversely affect the health of wildlife exposed to these substances.

In aquatic environments, the impact of uneaten fish food is particularly concerning. As the feed decomposes, it can lead to elevated levels of ammonia and nitrate, which disrupt the ecosystem's balance. High ammonia levels can be toxic to aquatic life, while increased nitrate levels can contribute to eutrophication, leading to excessive algae growth. This algae proliferation can further deplete dissolved oxygen in the water, creating hypoxic conditions detrimental to aquatic organisms. Additionally, the release of carbon dioxide during decomposition can lower the water's pH, further compromising water quality. These factors collectively contribute to poor water quality and can even cause mechanical failures in pumps used within the water source.

Another significant issue with current wildlife feeder timers is their failure to account for wind speed before or during feeding events. Wind can disperse the feed away from the designated distribution area, resulting in underfeeding of wildlife and wastage of feed. This not only leads to inefficient feeding but also worsens the problem of uneaten feed decomposing in unintended areas, further impacting the environment negatively.

Another significant issue with current wildlife feeder timers is their failure to consider the feeder's cardinal direction before or during feeding events, which is also crucial for protecting a wildlife feeder from environmental damage that either causes financial loss or a loss in feeding capabilities while down. In multiple commercial fish feeders, the timers are mounted in a hinged door that, when left open during rain events, can lead to damage to the control mechanisms. Without knowing the cardinal direction of the wildlife feeder, and the timer, it is not possible to know if the door was latched properly.

One significant problem with current wildlife feeders is the lack of remote control capabilities. Many feeder timers require manual operation, which can be inconvenient and inefficient, especially in remote or hard-to-reach locations. This limitation necessitates frequent physical visits to the feeder site, which can disturb wildlife and increase operational costs.

Additionally, existing wildlife feeder timers often lack robust network communication features. This deficiency hinders the ability to monitor and manage feeders from a distance. Without reliable network connectivity, users cannot receive real-time data or updates about the feeder's status, leading to potential issues such as overfeeding or depletion of feed.

Another issue is the difficulty in updating feeding event parameters. Current wildlife feeder timers typically require manual adjustments, which can be time-consuming and prone to human error. The inability to easily modify settings such as feeding schedules or quantities can result in inefficient feeding practices that do not align with the specific needs of the wildlife being supported.

Additionally, existing wildlife feeder timers in the current marketplace do not provide adequate alert systems. Users are often unaware of critical issues such as low feed levels, mechanical malfunctions, or unauthorized access. The absence of timely alerts can lead to disruptions in feeding schedules and negatively impact wildlife health and behavior.

Another significant problem with current wildlife feeder timers is their vulnerability to theft. Many feeders are placed in remote or secluded areas, making them easy targets for theft. The lack of effective security measures in existing designs means that feeders can be easily removed or tampered with, resulting in financial loss and disruption of wildlife feeding patterns.

Additionally, existing wildlife feeder timers often lack efficient tracking mechanisms. This deficiency makes it difficult for users to monitor the location and status of their feeders, especially when they are deployed over large areas or in difficult-to-access locations. Without reliable tracking, users may face challenges in maintaining and replenishing feeders, leading to inconsistent feeding schedules and potential negative impacts on wildlife.

These problems highlight the need for innovation in wildlife feeder timer design to improve compatibility, adaptability, efficiency, and sustainability. Accordingly, it would be beneficial to have a wildlife feeder system for and methods of distributing a type of feed that eliminates or otherwise limits the forgoing problems with current wildlife feeders and systems.

### SUMMARY

The present invention comprises inventions and systems related to fish and game feed dispensing devices and control thereof. The present invention further comprises a wildlife feeder timer and methods of providing a sophisticated solution for wildlife feeding management, ensuring optimal feeding practices through advanced technology integration and solution.

Specifically, in some embodiments, the present invention overcomes the incompatibility with multi-motor devices and systems and enhances adaptability for multi-feeder systems. In other embodiments, the present invention improves the efficiency of feed disbursement and incorporates the use of environmental information to optimize feeding. The instant invention allows for adjustments based on environmental conditions, thereby reducing wildlife feed wastage. Additionally, yet in other embodiments, the invention mitigates the impact on aquatic environments caused by food decomposition and considers cardinal direction and environmental conditions for optimal placement and operation. In some embodiments, the invention is configured for remote control capabilities and includes robust alert systems, facilitating easier management. In some embodiments, the instant invention simplifies the process of updating feeding event parameters, ensuring a more efficient and user-friendly experience.

In certain embodiments, the wildlife feeder timer is equipped with a mechanism to modulate the power supplied to one or more feed dispensation motors. This modulation allows for the adjustment of the feed throw distance. This feature provides significant adaptability, enabling the apparatus to be tailored to different food plot areas or bodies of water. In outdoor freshwater aquaculture systems, for instance, there are often multiple grow ponds containing fish at various growth stages. These ponds are typically designed as sequential rectangular strips, where the width is considerably shorter than the length. Traditional feeding systems often have a default throw distance that is too extensive, causing most of the food to miss the water body. The proposed apparatus, however, allows for precise modulation of the throw distance, which can be configured remotely or locally via integrated radio modules. This adaptability empowers a user to optimize the feeding system for their specific water bodies, ensuring efficient feed delivery.

Furthermore, uneaten fish food can lead to water contamination as it decomposes, releasing nitrites and ammonia into the water. These pollutants, along with the consumption of oxygen during decomposition, can significantly stress the fish, potentially reducing their growth or causing mortality in severe cases. To address this, some embodiments of the wildlife feeder timer include the capability to communicate with one or more water quality sensors. These sensors are designed to measure various water parameters, either individually or simultaneously, depending on the sensor's make and model. By utilizing these sensors, the apparatus can alert a user to adverse water conditions that require immediate attention to maintain fish health or water quality. Additionally, the system can autonomously adjust the amount of food dispensed to mitigate water degradation.

In some embodiments, the instant invention is configured to control one or more external devices. In other embodiments, the invention is configured to manage one or more external devices, providing a versatile solution for automated wildlife feeding operations. In some embodiments, the invention incorporates advanced communication protocols to facilitate digital interaction with external devices. For example, in some embodiments, the invention may utilize Modbus, a widely recognized communication protocol, to establish seamless connectivity and control. In some embodiments, the invention is configured to interface with external actuation systems, such as water pumps, circulators, and aerators. This capability allows the wildlife feeder timer not only to monitor water quality but also to implement corrective measures to enhance water conditions when necessary. In other embodiment, the instant invention employs sensors and control algorithms that are finely tuned to detect changes in environmental conditions, triggering the appropriate response from the connected devices.

Existing wildlife and fish feeding systems lack these advanced features. Moreover, current wildlife and fish feeding systems make retrofitting these existing systems impractical due to cost or spatial constraints. In contrast, the instant invention is designed to be compatible with existing wildlife and fish feeders. This compatibility not only reduces the financial burden on the user but also allows them to leverage their current systems.

Overall, the instant wildlife feeder timer represents a significant advancement in wildlife and aquaculture feeding technology, offering enhanced adaptability, environmental monitoring, and integration capabilities that address the limitations of existing systems.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

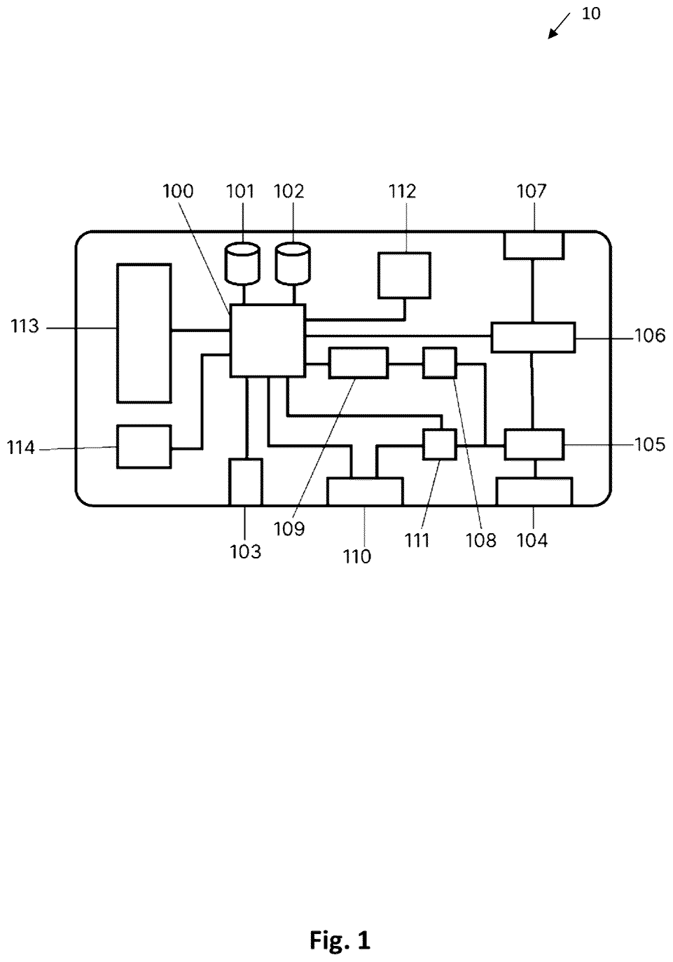

FIG. 1 is a schematic view of one embodiment of the instant invention.

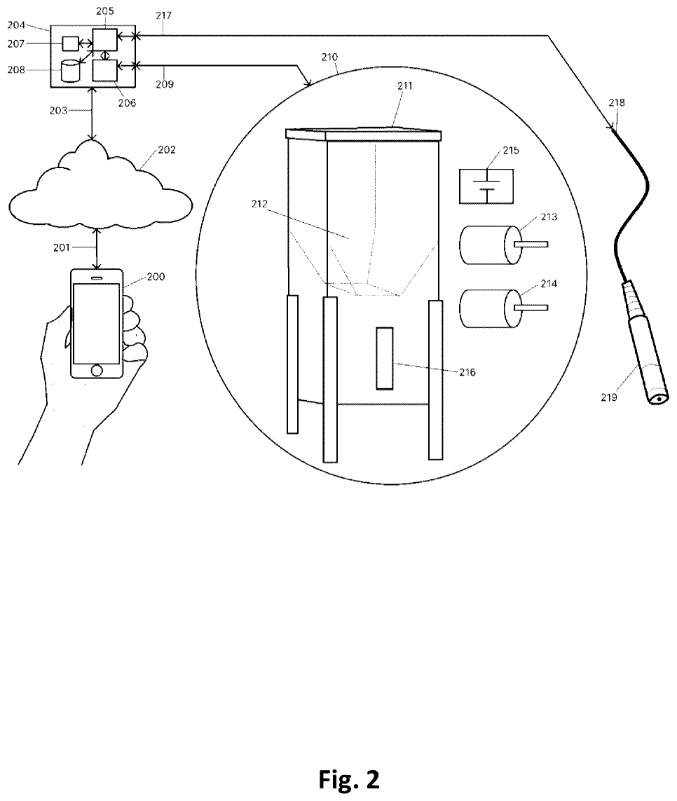

FIG. 2 is a schematic view of one embodiment of the instant invention.

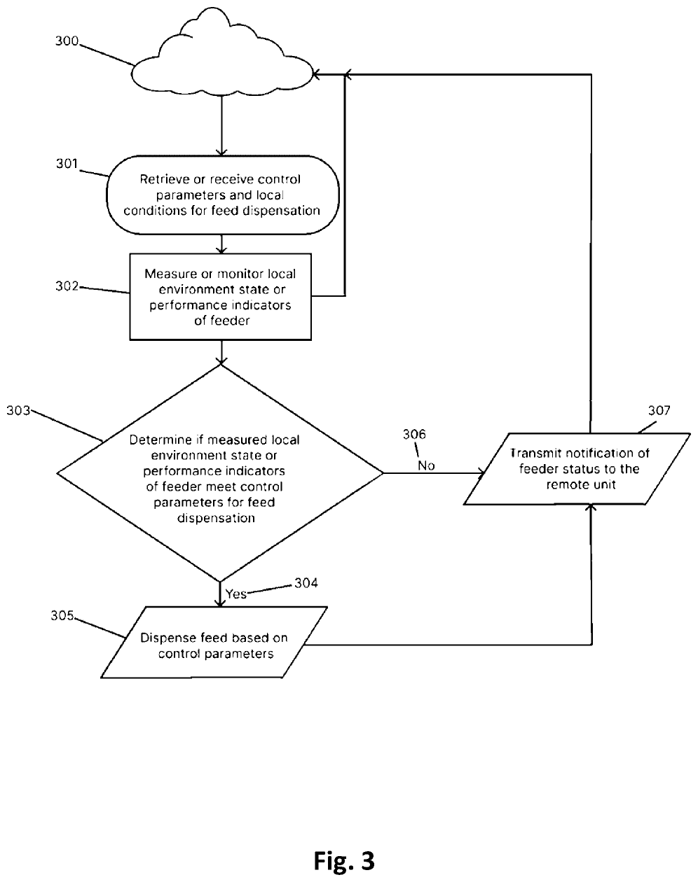

FIG. 3 illustrates a flow diagram of one embodiment of the present invention.

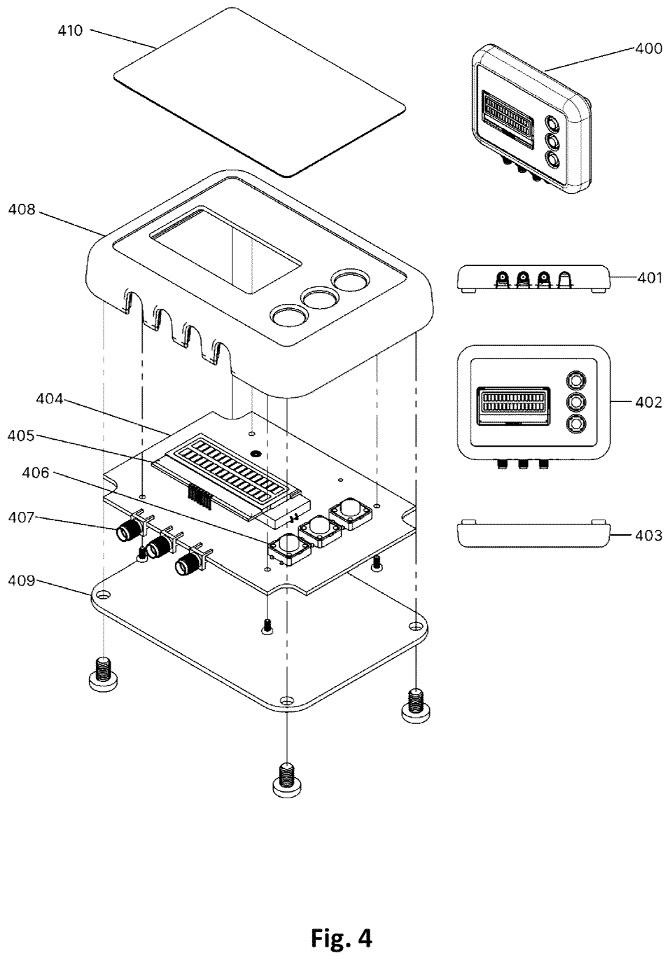

FIG. 4 is an exploded view of one embodiment of a control system and console of the present invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Generally referring to FIGS. 1 through 4, the present invention discloses a wildlife feeder device, control systems thereof, and methods for monitoring environmental conditions, controlling external water circulating or aerating devices, and dispensing wildlife feed configured according to the teachings of the invention.

Generally referring to the figures, in an exemplary embodiment of the present invention, the wildlife feeder timer includes, but is not limited to, processors, circuity, external devices, such as sensors, motors, and actuators, cloud servers, systems configured to connect into one or more networks, and is capable of being independently and remotely controlled, such that the wildlife feeder appropriately dispenses a wildlife feed. It is an object of some embodiments of the present invention to provide a device and method for a wildlife feeder system with the ability for dispensing a feed, or other type of granules. It is another object of some embodiments of the instant invention to provide system and methods configured for controlling and/or operating a wildlife feeder. Yet in other embodiments, the present invention is configured to enable users to connect, control, monitor, one or more wildlife feeders, third party feeders, equipment, device, or the like.

In some embodiments, the wildlife feeder timer 10 is integrated with electric circuitry that supports the operation of a processor 100, memory storage, and communication components. In a preferred embodiment of the instant invention, the circuitry is designed to ensure efficient power management and reliable operation of the wildlife feeder timer 10. In some preferred embodiments, the electric circuitry is a circuit board 404. In some embodiments, the wildlife feeder timer 10 is powered by a suitable electrical power source, which may include batteries, solar panels, or direct electrical connection.

Referring to FIG. 1, in an exemplary embodiment of the instant invention, the wildlife feeder timer 10 includes a processor 100. In some embodiments, the processor 100 is configured to control the instant invention's operations by implementing a method of monitoring, communicating, and controlling one or more external and internal devices coupled to the wildlife feeder timer 10. In some embodiments, the processor 100 comprises a multi-core architecture, allowing for parallel processing of tasks to optimize speed and resource utilization. Each core is equipped with an advanced instruction set architecture that supports a wide range of operations, including arithmetic, logic, control, and input/output functions. In some embodiments, the processor 100 further includes an integrated cache memory system, which reduces latency by storing frequently accessed data and instructions close to the processing units. In a preferred embodiment of the present invention, the processor 100 is designed with power management features that dynamically adjust power consumption based on workload demands, thereby improving energy efficiency.

In some embodiments, the wildlife feeder timer 10 includes communication means that enable interaction with external devices or networks. This may include wireless communication modules for remote monitoring and control, allowing users to adjust feeding parameters or receive alerts regarding the status of the wildlife feeder 10 and one or more connected devices. In a preferred embodiment of the instant invention, the wildlife feeder timer 10 includes one or more communication modules, communication modules such as radios; however, other communication module are contemplated by the instant invention. In some embodiments, the one or more radios are configured to interface with one or more networks, sensors, communication devices, cloud servers, and external and internal devices, such as external feeders, external and embedded sensors, and actuators. In some embodiments, the one or more radios are configured to facilitate wireless communication between the wildlife feeder timer 10 and other one or more electronic devices, networks, and cloud servers, via connectivity supporting multiple communication protocols. In some embodiments, the one or more radios are configured to utilize networks such as wide area networks (WAN). In some embodiments, the one or more radios are configured to utilize networks such as local area networks (LAN). In other embodiments, the one or more radios are configured to utilize both wide area networks and local area networks. In some embodiments, the one or more radios are configured to utilize, but are not limited to, cellular networks, satellite networks, Bluetooth, LoRa, Wi-Fi, radio LAN, Zigbee, and Global Navigation Satellite Systems (GNSS).

Referring to FIG. 2, in some embodiments, one or more radios are coupled to the wildlife feeder timer 10 and are internal, or embedded, radios 205. In some embodiments, the one or more radios may be coupled to a processor 100. Yet in other embodiments, the one or more radios may be external from the processor 100 and coupled to the wildlife feeder timer 10 though one or more networks or cables. In some embodiments, one or more radios may be external from the wildlife feeder timer 10 and are coupled to the wildlife feeder 10 though one or more networks or cables.

In some embodiments, the one or more radios are configured with embedded antennas. In some instances, it may be preferable to connect external antennas to the one or more radios. For example, if the wildlife feeder timer 10 is installed inside a metal box or in a remote location, it may be preferred to utilize external antennas for improved network connectivity. In some embodiments, the one or more radios are configured to couple with external antennas. Yet in other embodiments, an external antenna is coupled to one or more radios by connecting the external antenna to one or more antenna ports 103.

Referring to FIG. 1, in some embodiments, the wildlife feeder timer 10 may include one or more memory storage devices. In some embodiments, the one or more memory storage devices is a non-volatile memory storage medium 101. In some embodiments, the non-volatile memory storage medium 101 is coupled to the processor 100 and is configured to store control parameters for feeding events. The non-volatile memory 101 ensures that critical data related to feeding schedules, quantities, and other control settings are retained even when the system 10 is powered off. This allows for consistent and reliable operation of the wildlife feeder timer 10 without the need for reconfiguration after power interruptions.

In other embodiments, the one or more memory storage devices is a volatile memory storage medium 102. In some embodiments, the volatile memory 102 is coupled to the processor 100 and is configured to store process variables during computation or other tasks relevant to the wildlife feeder timer's 10 operation. In some embodiments, the volatile memory 102 is used for temporary data storage, facilitating real-time processing and decision-making by the processor 100. In some embodiments, the volatile memory 102 supports dynamic operations such as adjusting feeding parameters based on current environmental conditions or wildlife activity. Yet in other embodiments, the wildlife feeder timer 10 includes both non-volatile memory storage mediums 101 and volatile memory storage mediums 102.

Referring to FIGS. 1-4, in a preferred embodiment of the instant invention, the wildlife feeder timer 10 includes a power input port 104. In some embodiments, the wildlife feeder timer 10 includes a power input port 104, which serves as the primary interface for connecting an external power source. In some embodiments, the external power source may be a battery or another suitable charging device. In other embodiments, an external power source is connected to the power input port 104 to supply the necessary power for the operation of the wildlife feeder timer 10.

In certain embodiments, the input voltage at the power input port 104 is continuously monitored by the processor 100. This monitoring ensures that the wildlife feeder timer 10 operates within the desired voltage limits, thereby preventing unexpected shutdowns that could disrupt feeding schedules or damage the wildlife feeder timer 10. In some embodiments, when the wildlife feeder timer 10 is utilizing input power, monitoring circuitry 105 is employed to oversee the total power consumption of the wildlife feeder and connected devices. In other embodiments, monitoring circuitry 105 is employed for preventing the wildlife feeder and system's power consumption from reaching potentially damaging levels, such as when an actuator within the system is obstructed and unable to move freely.

Referring to FIG. 1, in some embodiments, the wildlife feeder timer 10 includes a power converter 108. In a preferred embodiment, a power converter 108 converters input power from an external power source, such as a battery, to appropriate operating power utilized by the wildlife feeder timer's 10 one or more components, such as the processor 100 and one or more radios, thereby reducing risk of damage to the relevant component. In other embodiments, the power converter 108 ensures that the electrical characteristics of the power supplied are compatible with the operational requirements of the processor 100 and one or more radios.

Referring to FIG. 1, in some embodiments, the wildlife feeder timer 10 includes monitoring circuitry 109. In a preferred embodiment, monitoring circuitry 109 is configured to monitor the converted power source from the power converter 108. In some embodiments, monitoring circuitry 109 is configured to ensure that downstream devices, such as the processor 100 and one or more radios, are functioning within expected power levels.

In some instances, it may be preferable to connect external devices, such as an actuator, to the wildlife feeder timer 10. Referring to FIG. 1, in some embodiments, an input power source is configured to connect to one or more external devices, such as actuators, through one or more relays 106. In some embodiments of the instant invention, component 106 is a relay or a MOSFET. In other embodiments, component 106 is an electric switch device. In some embodiments, the processor 100 controls the switching power to component 106. For example, in some embodiments, processor 100 supplies a DC voltage to component 106, such as a transistor gate or relay coil, thereby causing component 106 to change electrical states and enabling power to flow to the one or more external devices and starting the actuation of the one or more external devices based on the level of DC power applied. In other embodiments, component 106 is coupled to an output port 107 and facilitates the control of power flow to the one or more external devices. In some embodiments, processor 100 is configured to utilize component 106 to modulate or open/close one or more external devices, such as an external actuator. In some embodiments, processor 100 is connected to a power switching device 106, such as a MOSFET, which acts as an electronic switch to control the flow of electrical power. This configuration allows for the controlled operation of external devices, enhancing the versatility and adaptability of the wildlife feeder timer 10 to various environmental conditions and operational requirements.

Referring to FIG. 1, in a preferred embodiment, the wildlife feeder timer 10 includes an output port 107. In some embodiments, an output port 107 is configured to supply the proper voltage and current required by an external device, such as an actuator, pump, or motor. In some embodiments, external devices, such as actuators, pumps, or motors, are connected to the wildlife feeder timer 10 through an output port 107. In some embodiments, an output port 107 is configured to facilitate the opening/closing an external actuator. For example, in some embodiments, processor 100 is programmed to apply a DC voltage to the gate of the power switching device 106 at predetermined intervals. When the DC voltage is applied, the power switching device 106 changes its electrical state, enabling power flow to the output port 107. This action activates the connected external devices, initiating a process, such as a feeding, water circulation, or aeration process.

In some instances, it may be preferable to utilize external devices, such as one or more sensors, with the wildlife feeder timer 10. Referring to FIG. 1, in a preferred embodiment, the wildlife feeder timer 10 includes an output port 110. In some embodiments, an output port 107 is configured for analog control signals, such as 4-20 mA signals. In other embodiments, an output port 107 is configured for digital bus communication, such as Modbus communication. In some embodiments, output port 110 is designed to provide both input and output data, as well as power, to external sensors. The integration of external sensors allows for enhanced monitoring and control capabilities of the wildlife feeder system timer 10. In some embodiments, relay 111 is configured to control the electric power utilized by the external sensors. In some embodiments, relay 111 controls the flow of power through output port 110. For example, in some embodiments, processor 100 is programmed to apply a DC voltage to a relay coil of relay 111 at predetermined intervals. When the DC voltage is applied, relay 111 changes its electrical state, enabling power flow to the output port 110. In other embodiments, relay 111 is configured to deactivate, or shut off, the power supply to one or more external sensor, thereby conserving power consumption and battery storage. In a preferred embodiment, the wildlife feeder timer 10 can accommodate various types of sensors to gather diverse environmental and operational data. Examples of sensors that can be integrated include but are not limited to temperature sensors, pressure sensors, proximity sensors, light sensors, motion sensors, water quality sensors, pH sensors, thermocouple sensors, humidity, cardinal direction, barometric pressure sensors, active sensors, and passive sensors. In some embodiments, external sensors provide data that can be used by processor 100 to adjust feeding schedules, monitor environmental conditions, and ensure the proper functioning of the wildlife feeder timer 10.

In other embodiment of the instant invention, wildlife feeder 10 includes one or more output port 110, which facilitates communication with external devices via a protocol such as Modbus and is configured for the integration of high-power device control, as it allows the wildlife feeder timer 10 to send and receive signals to and from connected equipment. In some embodiments, the output port 110 allows the wildlife feeder timer 10 to communicate with external high-power devices, such as aerators or circulators, using the Modbus protocol. For example, a relay controlled over Modbus can be used to manage a high-power load like an aerator or circulator for a lake. This setup can be part of a feedback loop where, upon receiving data from an attached dissolved oxygen sensor indicating a low oxygen level, the wildlife feeder timer 10 activates an aerator to increase oxygen levels and prevent marine life loss. In some embodiments, the wildlife feeder timer 10 operates without a water quality sensor, sending control signals to an external device, such as a circulator or aerator, and circulating water on a regular schedule to prevent stratification.

In some embodiments, sensors are embedded 112 within the wildlife feeder timer 10 itself. These embedded sensors 112 are directly coupled to the wildlife feeder timer's 10 integrated electric circuitry, allowing for seamless data collection and processing. In other embodiments, sensors are coupled to the wildlife feeder timer 10 through one or more networks. This network coupling allows for remote monitoring and control, enabling users to access sensor data and adjust feeder operations from a distance. The network integration enhances the flexibility and scalability of the wildlife feeder timer 10, making it suitable for various environments and applications.

Referring to FIG. 1, in some embodiments, the wildlife feeder timer 10 includes a user interface 113. In some embodiments, a user interface 113 allows a user to control the wildlife feeder timer 10. In other embodiments, a user interface 113 allows a user to interrogate the wildlife feeder timer 10 to include, but not limited to, viewing and modify the control parameters of the wildlife feeder timer 10, view the measured sensor readings, or see operation of connected actuators and sensors. In some embodiments, a user interface 113 comprises one or more buttons 114. In some embodiments, a user interface display 113 and control buttons 114, are configured to enhance user interaction and operational management of the wildlife feeder timer 10. In a preferred embodiment, a user interface 113 and control buttons 114 are configured to allow a user to view measured sensor readings and real-time data. In some embodiments, a user interface 113 and control buttons 114 are configured so that users can make informed decisions regarding the control, adjustment, and maintenance of the wildlife feeder timer 10. In some embodiments, the interface 113 and buttons 114 offers data and insights into the operation of connected actuators and sensors. In some embodiments, the interface 113 and buttons 114 enable a user to observe the functionality and performance of connected actuators and sensors, ensuring that they are operating as intended.

Referring to FIGS. 1-4, in a preferred embodiment of the instant invention, the wildlife feeder timer 10 is configured to interface with one or more cloud servers 202. In some embodiments, the wildlife feeder timer 10 is coupled to a cloud server 202 by a communication link 203 through a network, such as a wide area network. In other embodiments, a remote cloud server 202 acts as a central hub for data exchange, enabling the wildlife feeder timer 10 to send and receive data 204 through a communication link 203. In some embodiments, data 204 may include, but is not limited to, operational control parameters, environmental sensor measurements, and operational metrics such as power draw levels from connected devices. In some embodiments, a remote cloud server 202 supports robust data 204 handling and storage, ensuring seamless communication between the wildlife feeder timer 10 and the user's mobile device 200. In an exemplary embodiment, the wildlife feeder timer 10 operates by establishing a connection 201, such as a wireless connection through a network, between the user's mobile device 200 and the remote cloud server 202. Through this connection 201, the user can control the wildlife feeder timer's 10 feeding events, monitor environmental conditions, and adjust operational parameters.

Referring to FIG. 2, in some embodiments, the wildlife feeder timer 10 comprises and is coupled to one or more radios. In some embodiments, the one or more radios are an embedded radio 205. In other embodiments, the one or more radios are not embedded on the wildlife feeder timer 10. In some embodiments, one or more radios are configured to transmit, receive, and utilize data 204. In some embodiments, the wildlife feeder timer 10 comprises a port 206 for connecting external actuators and power sources, facilitating direct control over mechanical components. In other embodiments, a wildlife feeder timer 10 comprises sensors 207 embedded within the apparatus to measure environmental variables, providing real-time data for operational adjustments. In some embodiments, a wildlife feeder timer 10 comprises a database 208 for storing received data, ensuring historical data is available for analysis and optimization. In some embodiments, a wildlife feeder timer 10 comprises a communication link 209 between the apparatus and a feeder system 210, enabling the wildlife feeder timer 10 for synchronized operation and control of the feeder system 210. In some embodiments, a communication link 209 is a physical link such as a wire or cable. In some embodiments, feeder system 210 is sourced from third-party vendors and is designed to dispense feed to game or fish. In other embodiments, feeder system 210 may comprise mechanical structure 211 to support the system, an internal hopper 212 for storing feed, one or more actuators 213, 214 for dispensing feed, an internal battery 215, and exhaust port 216 for feed dispensation.

Referring to FIG. 2, in some embodiments, the wildlife feeder timer 10 comprises a means to communicate with one or more external sensors 217. In some embodiments, one or more external sensors 217 is an environmental sensor. In some embodiments, the connection 218 between the wildlife feeder timer 10 and one or more external sensors 217 may utilize a molded plastic housing with electrically conductive pins 219, providing both power and data transfer capabilities between the wildlife feeder 10 and the one or more external sensors 217. In some embodiments, the connection 218 between the wildlife feeder timer 10 and one or more external sensors 217 may utilize a signal cable, such as a twisted pair shielded cable. In some embodiments the connection between the wildlife feeder timer 10 and one or more sensors may utilize a wireless channel, such as Bluetooth, Zigbee, or LoRa.

In some embodiments, a remote cloud server 300, as depicted in FIG. 3, serves as the central hub for data exchange with the wildlife feeder timer 10. In some embodiments, server 300 is capable of both sending and receiving data, thereby enabling dynamic control and monitoring of the wildlife feeder timer's 10 operations. In a preferred embodiment, the wildlife feeder timer 10 initiates data retrieval 301, which encompasses a range of control parameters utilized for the wildlife feeder timer's 10, or a connected third-party feeder 210, feed dispensation. These parameters include, but are not limited to, thresholds and limits for environmental sensor measurements, wind speed and direction, sunrise and sunset times at the installation location, and current air temperature and humidity.

Referring to FIG. 3, in some embodiments, the wildlife feeder timer 10 is equipped with a Global Navigation Satellite System (“GNSS”) radio, enabling precise location tracking of the wildlife feeder timer 10. In some embodiments, a remote cloud server 300 retrieves and utilizes the wildlife feeder timer's 10 location, by retrieving location information from the wildlife feeder timer's 10 GNSS radio. In some embodiments, a remote cloud server 300 retrieves and utilizes the wildlife feeder timer's 10 location, by retrieving location information from the wildlife feeder timer's 10 GNSS radio and the cloud server 300 utilizes the retrieved location information to retrieve local information, such as local weather data, from third party services. In some embodiments, the wildlife feeder timer 10 retrieves data, such as local weather information, from a cloud server 300 and may utilize the data retrieved from the cloud server for one or more of the wildlife feeder timer's 10 operations or processes. In some embodiments, once the information has been retrieved from a cloud server 300, the apparatus, if connected to onboard or external sensors, can retrieve readings from the local environment that are not accessible solely through GNSS radio location 301. In a preferred embodiment, upon gathering the necessary data, the wildlife feeder timer 10 evaluates whether feeding is appropriate 303. This determination is based on the control parameters and thresholds or limits established for the system. In some embodiments, if feeding is deemed appropriate 304, the apparatus utilizes the feed event control parameters to activate the feeder system, or one or more feeding systems of a connected third-party feeder 210, thereby effectuating the desired operation 305. In some embodiments, scenarios where feeding is not appropriate, as determined in step 306, the wildlife feeder timer 10 transmits the collected measurements and its operational determinations back to the remote cloud server 300, as depicted in step 307. If the feeding is deemed appropriate and successful, the wildlife feeder timer 10 transmits its measurements and determinations to the remote cloud server 300, as depicted in step 307. In the case of 306 encountering a feeding issue, such as actuator current limits being exceeded or the amount of feed quantity, such as the amount of feed in the hopper, being too low, this information and determination will also be transmitted during 307.

In an exemplary embodiment of the instant invention, the wildlife feeder timer 10 utilizes (GNSS) radios to accurately determine its geographical location. In some embodiments, the wildlife feeder timer 10 integrates a security mechanism that alerts the user if the feeder is moved from its location. In some embodiments, a user defines the wildlife feeder timer's 10 specific location and the wildlife feeder timer 10 alerts the user if the feeder is moved from its specific location. In other embodiments, the wildlife feeder timer 10 determines its specific location and the wildlife feeder timer 10 alerts the user if the feeder is moved from its specific location.

In a typical use case, the wildlife feeder timer 10 is installed in a remote location to provide feed for animals, game, or fish. In some embodiments, the wildlife feeder timer 10 uses the GNSS radios determine the wildlife feeder timer 10 feeder's location, and the cloud server 300 monitors this data. In some embodiments, if the wildlife feeder timer 10 is moved due to environmental factors, theft, or tampering, an alert is sent to the user via the cloud server 300. In some embodiments, if the wildlife feeder timer 10 is moved due to environmental factors, theft, or tampering, an alert is sent to the user via a network to the use's mobile device. In some embodiments, the network may include Wi-Fi, cellular, or other wireless communication technologies.

Referring to FIG. 4, in a preferred embodiment, the wildlife feeder timer 10 is equipped with an internal circuit board 404. In some embodiments, the circuit board 404 serves as the central hub to which various components, such as a user interface display 405 and buttons 406, connectors, and ports, such as antenna ports 407, are mounted. In some embodiments, the wildlife feeder timer 10 comprises an enclosure being configured to protect the internal components while providing accessibility for user interaction and external connections. In some embodiments, the enclosure includes a top half shell 408 and a bottom half shell 409. In some embodiments, a top half shell 408 is configured to expose one or more antenna ports, a user interface display 405, and one or more buttons 406. In other embodiments, a top half shell 408 includes additional openings to accommodate various ports necessary for connecting the feeder system and external environmental sensors. In some embodiments, the bottom half shell 409 provides a stable platform for the feeder, ensuring it remains securely positioned during operation. In other embodiments, the bottom half shell 409 serves to shield the circuit board 404 from environmental elements, thereby preserving the functionality and longevity of the internal components. In some embodiments, the wildlife feeder timer 10 includes a weather-resistant sticker 410 is affixed to the top of the enclosure. In some embodiments, sticker 410 is specifically designed to prevent water ingress through enclosure openings, such as the user interface opening, thereby safeguarding the electronic components from moisture-related damage.

In some embodiments, the wildlife feeder timer 10 is configured to modulate the power supplied to one or more motors, such as a feed dispensation motor. This modulation allows for the adjustment of the feed throw distance, ranging from a relative 0% to 100%. For example, when the full battery voltage is delivered to a motor, the feeder motor dispenses food at the maximum throw distance of 100%. Conversely, supplying half of the battery voltage results in a reduced throw distance of 50%. This feature provides significant adaptability, enabling the apparatus to be tailored to different food plot areas or bodies of water.

In some embodiments, the processor 100 is equipped with an output, such as a general purpose IO pin, configured to generate a pulse width modulated output signal. This modulation is achieved by utilizing one or more output pins of the processor 100 to produce modulated output signals. In a preferred embodiment, the processor 100 includes control circuits that is configured to manage or electrically operate the gate signal on relays, which provide power to external devices such as motors. The signal flow begins at the processor 100, where the pulse width modulated signal is generated. This signal is then transmitted through the control circuit to one or more relays or MOSFETs, which modulate the power supplied to the motors, thereby modulating the power supplied to one or more external devices, such as motors, pumps, or aerators. In some embodiments, the processor 100 may include additional output pins to generate multiple modulated signals, allowing for the control of multiple external devices, such as motors, pumps, or aerators, simultaneously.

In a preferred embodiment, the wildlife feeder timer 10 is configured for managing the operation of one or more motors and/or actuators, including the timing when an amount of feed is dispensed, feed throw distance, and an amount of feed dispensed. In some embodiments, the wildlife feeder timer 10 is coupled to one or more sensors. These sensors are strategically positioned to gather environmental data relevant to the operation of the wildlife feeder timer 10. The sensors may include, but are not limited to, wind speed sensors, cardinal direction sensors, and water quality sensors. In some embodiments, the data retrieved from the one or more sensors is processed by the wildlife feeder timer 10 to optimize a feeding process. In other embodiments, the wildlife feeder timer 10 utilizes third-party data, such as weather forecasts or timestamp information, to enhance its operational efficiency, feed timing, amount, and throw distance. This data is integrated into the processors 100 decision-making process, allowing the wildlife feeder timer 10 to adjust its operation based on predicted weather conditions or specific time intervals.

In some embodiments, the wildlife feeder comprises one or more sensors being configured to monitor the position of one or more doors, such as a hinged door when the wildlife feeder is mounted in an enclosure or box. In a preferred embodiment, the instant invention includes a plurality of sensors, which may include proximity sensors or limit type switch inputs, are strategically positioned to monitor the position of one or more doors, such as a hinged door, particularly when the wildlife feeder timer 10 is mounted within an enclosure or box. In some embodiments, one or more sensors are configured to detect the state of the doors, whether open or closed, and relay this information to the control unit. Additionally, in some embodiments, the wildlife feeder timer 10 is equipped with one or more directional sensors capable of obtaining a first cardinal direction relative to the device 10. This feature allows the wildlife feeder timer 10 to assess its orientation, adjust operations accordingly, log its orientation data, and send alerts to a user. Furthermore, as the wildlife feeder timer 10 collects and processes environmental data, if a sensor detects that one or more doors are in a first state, such as an open position, the control unit 100 evaluates the situation, and if adverse weather conditions are detected, and the cardinal direction suggests potential impact on the wildlife feeder timer's operation or the risk of damage, the device 10 sends an alert to the user. The wildlife feeder timer 10 can be configured in various embodiments to suit different operational needs. In some embodiments, the device may include additional sensors for enhanced monitoring capabilities or alternative power sources for increased efficiency. The design may also be adapted to accommodate different types of enclosures or feeding mechanisms, providing flexibility in application.

In some embodiments, the wildlife feeder timer 10 may utilize a combination of information gathered from one or more sensors and third-party data. In some embodiments, the wildlife feeder timer 10 may utilize a combination of information gathered from one or more sensors and third-party data to make informed decisions regarding feed time, feed throw distance, and feed distribution amount. For instance, the feeder timer 10 may determine an optimal feed time by analyzing sensor data on wind speed and direction alongside weather forecast data. Similarly, the feed throw distance and distribution amount can be adjusted based on a combination of real-time sensor data and external information.

In some embodiments, the wildlife feeder timer 10 is designed to control one or more other wildlife feeders. In some embodiments, the wildlife feeder timer 10 is designed to control one or more other wildlife feeders, such as a third-party feeder. In an exemplary embodiment of the instant invention, the primary wildlife feeder timer 10 sends signals through a networked communication to secondary feeders, coordinating their operation to ensure synchronized feeding across multiple locations. In some embodiments, the processor 100 employs algorithms to process sensor data and third-party information, executing commands to one or more feed dispensing mechanisms based on predefined parameters.

In one embodiment of the instant invention, the wildlife feeder timer 10 operates in one or more modes. In some embodiments, the wildlife feeder timer 10 is configured to operate in a first mode. In this mode, the system is programmed to wake up at predetermined intervals, governed by an internal timer. Upon activation, the system initiates communication with a remote cloud server 202 to obtain updated control parameters and thresholds necessary for sensor measurements. These parameters are utilized for determining the conditions under which feeding events should occur. In some embodiments, the wildlife feeder timer 10 is configured to handle scenarios where the server 202 is unreachable, either due to poor signal reception or service outages. In such cases, the wildlife feeder timer 10 is equipped with non-volatile memory that stores previously retrieved control parameters. This ensures that the wildlife feeder timer 10 can continue to function effectively even in the absence of real-time server 202 updates. In some embodiments, once the control parameters are established, the wildlife feeder timer 10 proceeds to gather data from one or more sensors, such as external and embedded sensors. With the two sets of data, the wildlife feeder 10 will compare the data to the programmed thresholds and limits and if the invention determines that the data is within appropriate limits, a feed event will be started. In some embodiments, if the wildlife feeder timer 10 determines any anomalies, such as an actuator current exceeding a predefined threshold or a low battery voltage within the wildlife feeder timer 10, the feeding event will be aborted.

In some embodiments of the instant invention, the wildlife feeder timer 10 is programmed to report the results back of both successful and aborted feeding events to the remote cloud server 202. In other embodiments, both successful and aborted feeding event results are stored in the non-volatile memory, providing a local record of the wildlife feeder timer's 10 activities. In some embodiments, the wildlife feeder timer 10 provides an alert message to a user including information regarding both successful and aborted feeding events. In some embodiments, after both successful and aborted feeding events, the wildlife feeder timer 10 will reenter a sleep state, conserving energy until a next wake-up event.

In some embodiments, a second control loop is initiated by the remote cloud server 202 or the local area network communications radio. In that case, either the wildlife feeder timer 10 will wake up as in the first control loop, the local area network communication radio will wake the wildlife feeder timer 10 up, or the remote cloud server 202 will wake the instant invention up. Once the wildlife feeder timer 10 is awake, it will start processing the signal sent from the local area network communication radio or the remote cloud server 202. This signal could be for any purpose, such as an immediate feeding event, an immediate measurement of a connected onboard or external sensor, or any such appropriate command. Once this process is completed, the wildlife feeder timer 10 will report back the results of this command to the initiator, as well as the remote cloud server 202, if it did not initiate the command.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An animal or fish feeder apparatus that can communicate with an animal or fish feeder, comprising:
a controller capable of communicating with at least two communication modules;
a local area network communication module;
a wide area network communication module comprising a telecommunications device to send and receive data to the cloud server outside of the range of the local area network module;
a radio navigation system communication module;
a communication port to connect various sensors external to the apparatus to acquire relevant values from the local environment;
one or more sensors within the apparatus to acquire relevant values from the local environment measurable from within the apparatus; and
one or more relays to connect an input power source to an output power sink.

2. The apparatus of claim 1, wherein the local area network communication module is capable of operating over multiple protocols, including Bluetooth Low-Energy (BLE) for short-range communication and LoRa for long-range, low-power communication, enabling flexible deployment in diverse environmental conditions.

3. The apparatus of claim 2, wherein the wide area network communication module comprises a cellular telecommunications device.

4. The apparatus of claim 2, wherein the wide area network communication module comprises a satellite communications device.

5. The apparatus of claim 1, wherein the communication port comprises a serial communication module to communicate with a plurality of sensors including, but not limited to, a dissolved oxygen sensor, a pH sensor, or a camera.

6. The apparatus of claim 1, wherein a first sensor within the apparatus is an integrated barometric pressure sensor for calibrating the data acquired from a water quality sensor, including, but not limited to, a dissolved oxygen sensor.

7. The apparatus of claim 1, wherein a first sensor within the apparatus is an integrated digital compass sensor or similar, designed to determine the apparatus's orientation by measuring the Earth's magnetic field, enabling the apparatus to establish its cardinal direction, facilitating precise control over operational functions based on geographical orientation.

8. The apparatus of claim 7, wherein the apparatus's established cardinal direction is utilized to adaptively manage feed dispersal, with the system configured to automatically suspend feed distribution when wind speeds exceed predefined thresholds in certain cardinal directions, optimizing feed usage and mitigating waste, wherein the local wind speeds are retrieved via the wide area network communication module based on the geographic location retrieved via the global navigation satellite system (GNSS) communication module from a third party web service.

9. The apparatus of claim 7, wherein the cardinal direction of the apparatus, when the apparatus is installed on a hinged door, is used to alert the user that the feeder door has been left open.

10. The apparatus of claim 5, wherein the plurality of connected sensors can be disconnected from power using a relay coupled to the processor, extending battery life of the system.

11. The apparatus of claim 1, wherein the radio navigation system communication module is configured to support one or more global navigation satellite systems (GNSS), including but not limited to the Global Positioning System (GPS) and the Galileo navigation satellite system, enabling precise location tracking and functionality across different geographic regions and conditions.

12. The apparatus of claim 1, wherein the radio navigation system communication module, capable of utilizing data from any supported global navigation satellite system (GNSS), is used to establish a virtual geofence of a user-defined radius around the feeder's real-world geographic location, enabling proactive security measures, including but not limited to, notifying the user if the feeder moves beyond the established virtual perimeter, thereby enhancing the feeder's security against unauthorized relocation or theft.

13. The apparatus of claim 1, featuring a radio navigation system communication module configured to utilize data from any supported global navigation satellite system (GNSS), for establishing a virtual geofence with a user-defined radius around the feeder's geographic location. The system is configured to automatically send a notification to the user's device via the wide area network communication module if the feeder is moved beyond the virtual geofence, providing a security feature against unauthorized movement or theft.

14. The apparatus of claim 5, wherein the communication port is used to communicate with high power actuation devices, such as aerators or circulators, that are configured to have their state modified and queried over a serial communication link.

15. The apparatus of claim 14, wherein the high power actuation devices have their states changed in a feedback loop with the connected water quality sensors to maintain the water quality at healthy levels for the wildlife in the body of water.

16. The apparatus of claim 15, wherein the state of the high power actuation devices have their states reported back to the user using the wide area network communication module, which may include, but is not limited to, state of water filters, current consumed, input voltage level, or pressure of water lines.

17. The apparatus of claim 1, wherein a coupled processor modulates the state of one or more output pins, which varies the electrical activation of one or more coupled relays, which varies the current being delivered to one or more coupled actuation devices, which varies the distance the animal feed is thrown.

18. A feeder system comprising:
a feed hopper providing an outlet for feed;
a spinning plate that meters the feed released from the outlet into a blower;
an actuator connected to the spinning plate and arranged to actuate the spinning plate when the actuator is powered;
a spinning blower to spread feed directionally;
a second actuator connected to the blower and arranged to actuate the blower when the actuator is powered;
a battery arranged to power both actuators; and
an apparatus according to claim 1 mounted on or within the feeder system, wherein the apparatus is connected to both actuators and the battery and controls the battery being connected to both actuators to spread feed.

19. A feeder system comprising:
a feed hopper providing an outlet for feed;
a spinning plate that scatters the feed radially as it is released from the outlet;
an actuator connected to the spinning plate and arranged to actuate the spinning plate when the actuator is powered;
a battery arranged to power the actuator; and
an apparatus according to claim 1 mounted on or within the feeder system, wherein the apparatus is connected to the actuator and battery and controls the battery being connected to the actuator to spread feed.

20. A method for integrating operational control, environmental adaptation, and communication functionalities within an animal or fish feeder system, the method comprising:
employing a controller configured to communicate with a plurality of communication modules, including local and wide area network modules, and a radio navigation system module, for comprehensive connectivity and data exchange;
utilizing a combination of embedded environmental sensors and external sensor inputs through a communication port to acquire real-time data on local environmental conditions, including but not limited to barometric pressure, dissolved oxygen, and the Earth's magnetic field;
processing the acquired environmental data to adaptively control feed dispersal mechanisms based on predefined environmental parameters and geographical orientation to optimize feed usage and mitigate waste;
establishing a virtual geofence using data from the radio navigation system module to enhance security by notifying the user of unauthorized movement or relocation of the feeder;
coordinating power management through control of power sources to actuators and sensors, incorporating diagnostic functionalities to monitor system power consumption and identify operational inefficiencies or malfunctions; and
utilizing coupled water quality sensors and coupled aerators or circulators to maintain water quality in a feedback loop.
